(19) United States
(12) Patent Application Publication
(10) Pub. No.: US 2011/0148975 A1
(43) Pub. Date: Jun. 23, 2011

(54) Dot Missing Inspection Method of Printing Device and Printing Device

(75) Inventor: Seiji Izuo, Nagano-ken (JP)

(73) Assignee: SEIKO EPSON CORPORATION, Tokyo (JP)

(21) Appl. No.: 12/966,378

(22) Filed: Dec. 13, 2010

(30) Foreign Application Priority Data
Dec. 22, 2009 (JP) 2009-291035

(51) Int. Cl. B41J 29/393

(52) U.S. Cl. 347/19

(57) ABSTRACT

A method of inspecting presence/absence of dot missing in a printing device for discharging and impacting liquid droplets of a light curable ink from nozzles onto a medium, irradiating light to the impacted liquid droplets so as to cure the liquid droplets, and forming an image formed of minute dots on the medium includes, at the printing device, discharging and impacting the liquid droplets of the light curable ink from the nozzles onto the medium, irradiating light including a predetermined wavelength component for curing the light curable ink toward the liquid droplets impacted on the medium, at a light receiving unit, selectively receiving the predetermined wavelength component from reflected light of the irradiated light and outputting a received light intensity signal, and determining the presence/absence of the dot missing based on the received light intensity signal output from the light receiving unit and outputting inspection result data indicating the determination result.

### CROSS-REFERENCE TO RELATED APPLICATION

Japanese Patent Application No. 2009-291035 is hereby incorporated by reference in its entirety.

### BACKGROUND

1. Technical Field

The present invention relates to a method of inspecting an ink impacted on a medium for missing dots in a printing device for intermittently discharging the ink on the medium and impacting the ink at a desired position on the medium, such as an ink jet printer, and a printing device including a dot missing inspection mechanism.

2. Related Art

As a printing device, an ink jet printer for intermittently discharging an ink onto various mediums such as paper, cloth, or a film so as to perform printing is known. The ink jet printer arranges minute dots formed of ink droplets on the medium so as to form an image. In the ink jet printer, for example, the medium is moved in a specific transport direction, an ink discharging head in which nozzles for discharging the ink over the width of the medium are fixed in a line shape or a zigzag shape is included, and the ink is discharged while the medium is moved in the transport direction so as to form the image. The ink is filled in an ink tank, is guided from the tank to a space which is called a reservoir in the head by a pump, and is then guided from the reservoir to a pressure chamber communicating with the nozzles. In addition, the ink is discharged from the nozzles by expanding and contracting the pressure chamber or the like. Thus, the ink droplets discharged from the nozzles are impacted at a desired position of a surface of the medium.

In addition, the ink jet printer described herein is of a type called a line printer. As the ink jet printer, in addition to this type, there is a type called a serial printer in which a head in which nozzles are arranged with a width narrower than that of a medium is reciprocally moved in a scan direction crossing a transport direction so as to land ink droplets discharged from the nozzles at a desired position of a surface of the medium.

However, in the ink jet printer, clogging may occur in the nozzles due to adhering of the ink and thus the ink may not be appropriately discharged. In addition, a malfunction may occur in a mechanism itself for discharging the ink and thus the ink may not be appropriately discharged. In this case, the liquid droplets of the ink are not impacted on the medium and so-called “dot missing failure” occurs. In addition, even in the case where the ink droplets are not impacted at a correct position, since the dot is not present at a position where the dot needs to be originally present, this case may also correspond to “dot missing failure”. To this end, in the ink jet printer, it is necessary to perform an inspection regarding the presence/absence of dot missing failure. In this inspection, for example, an image is formed such that dots on a medium are drawn in a predetermined pattern (test pattern) and the image is optically analyzed. This analysis may be performed using an optical sensor and an image recognition technology or may be performed by checking the printed test pattern visually. In either case, the inspection is performed by actually discharging the ink on the medium.

In the ink jet printer, various methods of actually performing printing with respect to recording paper and performing an inspection regarding the presence/absence of dot missing failure are proposed. For example, in a method described in JP-A-2005-35042, an image sensor is mounted in a printer, and a printed state is detected by the image sensor so as to check the presence/absence of dot missing. If missing dots are present, there is a mechanism in which a dot missing position is stored and is compensated by the other nozzles or the like at the time of printing. In either case, there is a method of printing a predetermined pattern or the like as an inspection image and inspecting whether or not missing dots are present in the inspection image using an optical device or visually.

In a printer which lands discharged ink droplets on a medium so as to form an image, such as an ink jet printer, when dot missing is optically inspected, as described above, an inspection image is printed and then it is determined whether or not predetermined dots are positioned at correct positions on the image. Accordingly, it takes a considerable time to perform the inspection. In addition, a large amount of ink is used for completely printing the inspection image. In addition, in the ink jet printer, there are various types according to the characteristics or types of used inks, methods of fixing ink droplets on a medium, or the like. In some types of printers, it was proved that there are several cases where it is difficult to optically inspect dot missing, such as the case where the color of the ink is similar to the color of the medium.

### SUMMARY

According to an aspect of the invention, there is provided a method of performing an inspection regarding the presence/absence of dot missing in a printing device for discharging and impacting liquid droplets of a light curable ink from nozzles onto a medium, irradiating light to the impacted liquid droplets so as to cure the liquid droplets, and forming an image formed of minute dots on the medium, the method including: at the printing device, discharging and impacting the liquid droplets of the light curable ink from the nozzles onto the medium; irradiating light including a predetermined wavelength component for curing the light curable ink toward the liquid droplets impacted on the medium; at a light receiving unit, selectively receiving the predetermined wavelength component from reflected light of the irradiated light and outputting a received light intensity signal; and determining the presence/absence of the dot missing based on the received light intensity signal output from the light receiving unit and outputting inspection result data indicating the determination result. The other features of the invention will be apparent from the present specification and the accompanying drawings.

### BRIEF DESCRIPTION OF THE DRAWINGS

The invention will be described with reference to the accompanying drawings, wherein like numbers reference like elements.

FIG. 1 is a block diagram showing the overall configuration of a printer according to an embodiment of the invention.

FIG. 2A is a partial-broken perspective view of the overall configuration of the printer and FIG. 2B is a transverse cross-sectional view of the overall configuration of the printer.

FIG. 3 is an explanatory diagram showing the arrangement of nozzles configuring the printer.

FIGS. 4A to 4D are schematic diagrams showing a basic printing operation of the printer.

FIGS. 5A to 5C are schematic diagrams showing the principle of dot missing inspection of the printer.

FIGS. 6A to 6E are schematic diagrams showing an operation in an inspection mode of the printer.

### DESCRIPTION OF EXEMPLARY EMBODIMENTS

### Regarding Optical Dot Missing Inspection

In a printing device for discharging an ink onto a medium so as to form an image such as an ink jet printer, if dot missing inspection is optically performed, an inspection image such as a test pattern is printed once and the printed image is read by an image scanner or the like. Then, the presence/absence of dot missing is detected depending on whether or not dots forming the image are positioned at correct positions. To this end, the time and the ink for printing the inspection image are wasted.

In addition, in the optical dot missing inspection, the contrast of the color of the ink may be much lower than the color of the medium and the dot may be difficult to detect. For example, there is a transparent ink which is called a clear ink discharged on an image formed by a color ink as a coated layer in order to improve image quality and prevent color degradation or color change. Even when liquid droplets of this clear ink land on the medium, as a matter of course, it is difficult to optically and selectively detect only the liquid droplets of the clear ink just by transmitting the dots of the color ink coated by the clear ink or the color of the medium.

In addition, there is a “white ink”. This white ink is used for preventing a background portion, in which printing is not originally performed, or the color of a color image from depending on an underlying color of a medium when printing is performed with respect to a transparent medium such as a clear sheet. Certainly, if a clear sheet is used for dot missing inspection, the contrast ratio of a background color is increased and optical detection may be easily performed. However, the clear sheet has high cost and high inspection cost as compared with a paper medium. Even with the white ink, it is more preferable that inspection be performed using a cheap medium such as paper. Depending on the background color, it may be difficult to detect colored ink other than a white color.

In recent ink jet printers, in order to enrich the color representation, inks of more colors are used. Among the ink colors, for example, there are inks of a relatively pale color as compared with the other colors, such as light yellow. Alternatively, for industrial application, there may be a case where an ink of a color similar to that of a medium is used, such as a case where an ink having chromaticity in a predetermined range of the chromaticity of a medium is used on the medium having predetermined chromaticity. There are several cases where it is difficult to perform optical dot missing inspection without being limited to transparent or white ink.

### Regarding Embodiment/Example of the Invention

As described above, in order to optically detect dot missing in a printing device such as an ink jet printer, an inspection image needs to be printed (printed out) to the end and considerable time and ink are necessary and thus inspection cost is increased. In addition, a problem occurs in an optical dot missing inspection method itself, due to the color of the ink or a combination of the color of the ink and the color of the medium. As the result of examining various printing methods of a printing device for discharging and impacting an ink on a medium, it was proved that, in a printing device which employs a specific printing method, the above problem is solved at once by skillfully using the structure or configuration.

In detail, in a printing device, there is a type using a light curable ink cured by ultraviolet rays or visible light. In this type of printing device, light is irradiated to an ink impacted on a medium and liquid droplets of the ink are cured and fixed on the medium. That is, the ink absorbs light of a predetermined wavelength component so as to be cured. Accordingly, if curing light is used as light irradiated to the dot when optical dot missing inspection is performed, the predetermined wavelength component is absorbed when the light is irradiated to the dot and, if the presence/absence of absorption is detected, the presence/absence of the dot is determined.

However, the detection of the presence/absence of absorption is performed by irradiating the light from the curing light source to ink droplets on the medium and analyzing the wavelength component of the reflected light thereof. In order to perform the analysis, it is not necessary for an expensive complicated spectrophotometer to be built into a printing device. It takes considerable time to measure spectral intensity.

Accordingly, the embodiment of the invention is a printing device using a light curable ink, and a method of performing optical dot missing inspection reliably and at low cost in the printing device is the embodiment of the invention. The embodiment of the invention has the following characteristics in addition to the main features of the invention.

The method may further include performing permanent curing, in the irradiating of the light, the light from a first light source for individually irradiating the light to the liquid droplets impacted on the medium may be irradiated and the liquid droplets may be temporarily cured so as to prevent the flow of the liquid droplets, in the receiving of the light, each reflected light of the light individually irradiated by the first light source to each of the liquid droplets may be received by the light receiving unit and the individual received light intensity signal is output to each of the liquid droplets, and, in the performing of the permanent curing, the light from a second light source may be irradiated to the liquid droplets temporarily cured by the irradiating of the light so as to further cure the liquid droplets to be fixed on the medium.

The discharging of the ink may be paused when the inspection result data indicating that missing dots are present is output in the outputting of the inspection result data.

A printing device according to the embodiment of the invention includes a head unit including a plurality of nozzles, a light irradiation unit, a dot missing detection unit, and a control unit configured to control the head unit, the light irradiation unit and the dot missing detection unit, the head unit discharges and lands liquid droplets of a light curable ink from the nozzles on a medium, the light irradiation unit irradiates light including a predetermined wavelength component for curing the light curable inks toward the liquid droplets impacted on the medium, the dot missing detection unit includes a light receiving unit and a wavelength selection unit, the light receiving unit receives reflected light of the light irradiated by the light irradiation unit and outputs a received light intensity signal to the control unit, the wavelength selection unit selectively transmits the light of the predetermined wavelength component through an optical path of the reflected light such that the transmitted light enters into the light receiving unit, and the control unit determines the presence/absence of dot missing based on the received light intensity signal from the light receiving unit and outputs inspection result data indicating the determination result.

### Embodiment

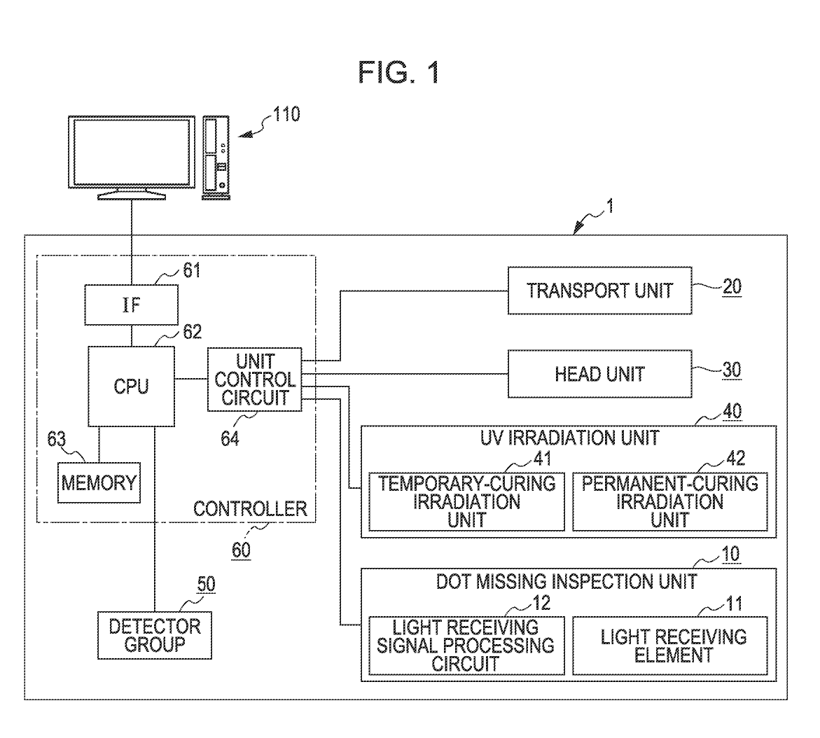

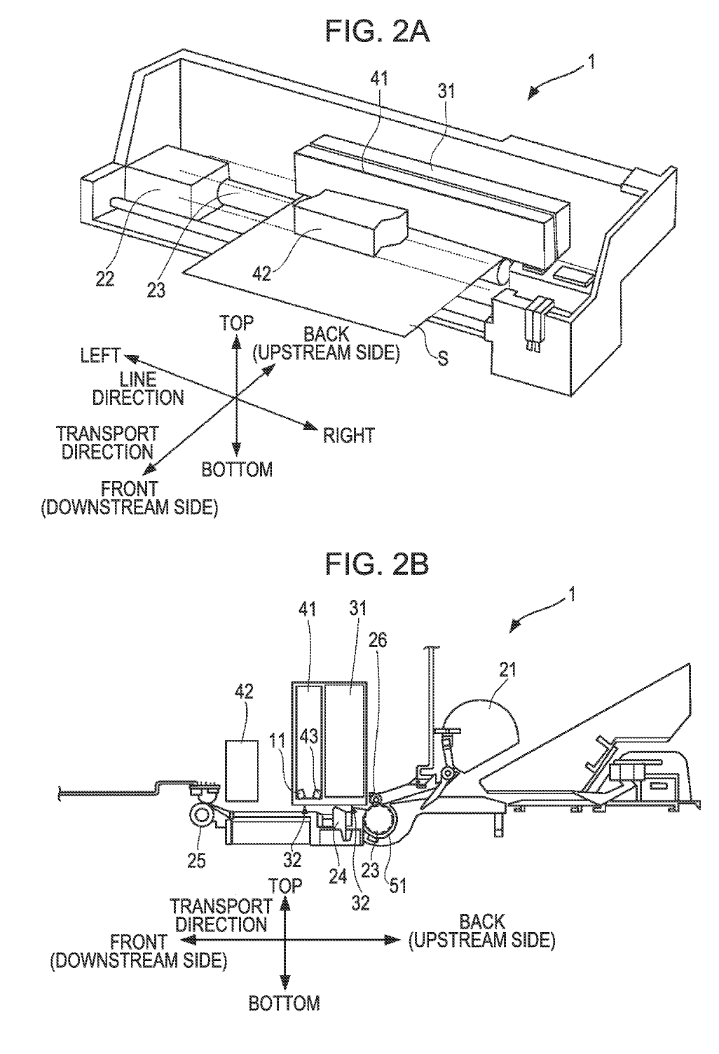

As an embodiment for realizing an example of a dot missing inspection method of the invention, an ink jet printer (hereinafter, referred to as a printer) using an ink (UV ink) cured by ultraviolet (UV) rays will be described. FIG. 1 is a block diagram showing the overall configuration of a printer 1. FIGS. 2A and 2B show the schematic structure of the printer 1. FIG. 2A is a partial-broken perspective view of the printer 1 and FIG. 2B is a transverse cross-sectional view of the printer 1. The printer 1 described herein is a line printer in which a head extends over a width direction (hereinafter, referred to as a line direction) of a medium, and includes a transport unit 20, a head unit 30, a detector group 50, a controller 60, a UV irradiation unit 40, as a basic configuration. In addition, a dot missing inspection unit 10 is included as a unique configuration of the present embodiment.

The controller 60 is a control unit for performing the control of the printer 1, and includes a CPU 62, which is an arithmetic processing device, a memory 63 including a storage element such as a RAM or an EEPROM and securing a storage region of a program executed by the CPU 62, a working region of the program, and a variety of data to be processed by the program, a unit control circuit 64 mediating data communication between the units 10, 20, 30 and 40 and the CPU 62, and an interface unit (IF) 61 for performing data transmission or reception between an external device (hereinafter, referred to as a PC) 110 such as a personal computer and the printer 1.

The detector group 50 includes various sensors for detecting various statuses in the printer 1, and the sensors included in the detector group 50 output detection results (detection data) to the controller 60. In addition, the detector group 50 includes, for example, a rotary encoder 51 for detecting the rotation amount of a transport roller 23 and the like.

The transport unit 20 transports a medium S such as paper in a predetermined direction (hereinafter, referred to as a transport direction). This transport unit 20 includes a paper feeding roller 21, a transport motor 22, a transport roller 23, a platen 24, an ejection roller 25, and the like, as main components. The paper feeding roller 21 is a roller for feeding the medium S inserted into an insertion port of the medium S into the printer 1. The above-described transport roller 23 is a roller for pinching the medium S with a driven roller 26 so as to transport the medium S fed by the paper feeding roller 21 to a printable region, and is driven by the transport motor 22. The controller 60 may detect the movement amount of the medium S based on the rotation amount of the transport roller 23.

The platen 24 supports the medium S during printing. The ejection roller 25 is a roller which is provided on a downstream side of the transport direction of a printable region so as to pinch the medium S with a driven roller 27 and to eject the medium S to the outside of the printer 1. This ejection roller 25 is rotated in synchronization with the transport roller 23. In addition, the transport roller 23 and the ejection roller 25 are designed such that the lengths of the circumferences thereof become 1 inch, in order to enable the transport amount per one rotation to become 1 inch.

The head unit 30 is a configuration for discharging the ink toward the medium and includes a head 31 including nozzles, an ink tank, a pump for supplying the ink from the ink tank to the head, and the like. In addition, in the present embodiment, inks of a plurality of colors for multi-color printing are individually charged in ink tanks.

The UV irradiation unit 40 includes a light source for irradiating a light including UV rays of a predetermined wavelength range for curing the UV ink impacted on the medium S and fixing the ink on the medium S, a circuit for driving the light source, or the like.

The dot missing inspection unit 10 is a mechanism for inspecting whether or not liquid droplets are discharged from the nozzles and includes a light receiving element 11 such as a photo transistor, a light receiving signal processing circuit 12 for sampling and converting a signal from the light receiving element into digital data (light receiving data) or transmitting the light receiving data to the controller 60, and the like, in order to optically detect the presence/absence of liquid droplets impacted on the medium S.

### Basic Operation of Printer

The CPU 62 of the controller 60 executes the program stored in the memory 63, processes printing data received from the computer 110 through the IF 61 or detection data from the detector group 50, and controls the units 10, 20, 30 and 40 by the unit control circuit 64 based on the processed result. In this way, a printed image is formed on the medium S.

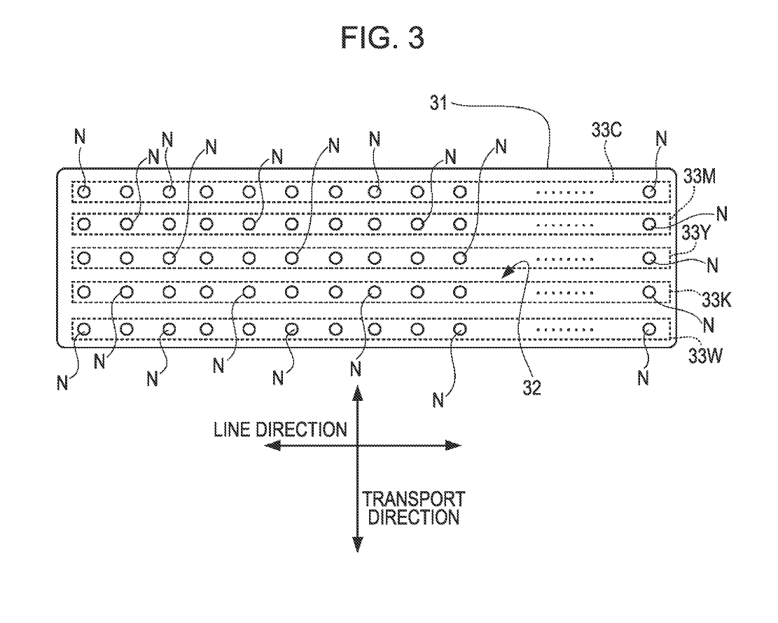

The printer 1 forms the printed image from liquid droplets of color inks, and the head unit 30 is a configuration for discharging ink droplets toward the medium S. A plurality of nozzles is opened in a lower surface 32 of the head unit 30. FIG. 3 shows arrangement of the nozzles N. In the lower surface 32 of the head 31, the plurality of nozzles N is opened side by side at a predetermined interval in the line direction. In the present embodiment, nozzle arrays 33K, 33C, 33M, 33Y and 33W are formed. The nozzle arrays 33K, 33C, 33M, 33Y and 33W are aligned at a predetermined interval along the transport direction, and the nozzle arrays 33K, 33C, 33M, 33Y and 33W respectively correspond to inks of different colors. In this example, the black ink nozzle array 33K, the cyan ink nozzle array 33C, the magenta ink nozzle array 33M, the yellow ink nozzle array 33Y and the white ink nozzle array 33W are formed.

In each of the nozzles N, an ink chamber (not shown) and a piezoelectric element are provided. If the ink chamber expands or contracts by driving the piezoelectric element, ink droplets are discharged from the nozzles N. The head 31 including such a configuration intermittently discharges the ink droplets while the medium S is transported, and the dots formed of the ink droplets on the medium S are two-dimensionally arranged on the medium S so as to form an image.

### UV Irradiation Unit

In the present embodiment, the light including the wavelength range of the ultraviolet rays is irradiated to the liquid droplets of the UV ink impacted on the medium S such that the liquid droplets (ink droplets) are cured as dots configuring the image. The UV irradiation unit 40 includes the light source for irradiating the light including the ultraviolet rays, the driving circuit for turning the light source on, and the like. The printer 1 of the present embodiment is a printer for performing so-called “temporary curing” of, for the purpose of preventing the flow of the liquid droplets, irradiating light with energy lower than that of light irradiated for the purpose of fixing to the liquid droplets of the ink immediately after impacting so as to cure the surfaces of the liquid droplets of the ink. The printer 1 includes a temporary-curing irradiation unit 41 for irradiating light (temporary-curing light) for performing temporary curing to the UV ink droplets impacted on the medium S and a permanent-curing irradiation unit 42 for irradiating light (permanent-curing light) for completely curing the UV ink droplets. In addition, ultraviolet LEDs or the like may be used as light sources of the temporary-curing irradiation unit 41 and metal halide lamps or the like may be used as light sources of the permanent-curing irradiation unit 42.

Here, the line direction is the left and right direction, and the ejection direction of the medium S in the transport direction is a front side or a downstream side. As shown in FIG. 2, if the left and the right are defined in the line direction when viewed from the front surface of the printer 1, the head 31, the temporary-curing irradiation unit 41, and the permanent-curing irradiation unit 42 are arranged from the upstream side to the downstream side in this sequence, and temporary curing is performed by irradiating the temporary-curing light with low energy to the UV ink droplets when the UV ink is discharged from the head 31 during the transport of the medium S so as to land the UV ink droplets on the medium S. Regarding the light sources of the temporary-curing irradiation unit 41, the same number of LEDs as the number of nozzles N included in the nozzle arrays 33K, 33C, 33M, 33Y and 33W are arranged substantially at the same position as the nozzles with the same pitch along the line direction.

The permanent-curing irradiation unit 42 is provided to extend in the line direction such that the irradiation range of the permanent-curing light is longer than the width of the medium S to be printed. The permanent-curing irradiation unit 42 irradiates the permanent-curing light toward the medium S when the medium S is moved in the transport direction. In this way, the UV ink droplets temporarily cured on the medium S are completely cured.

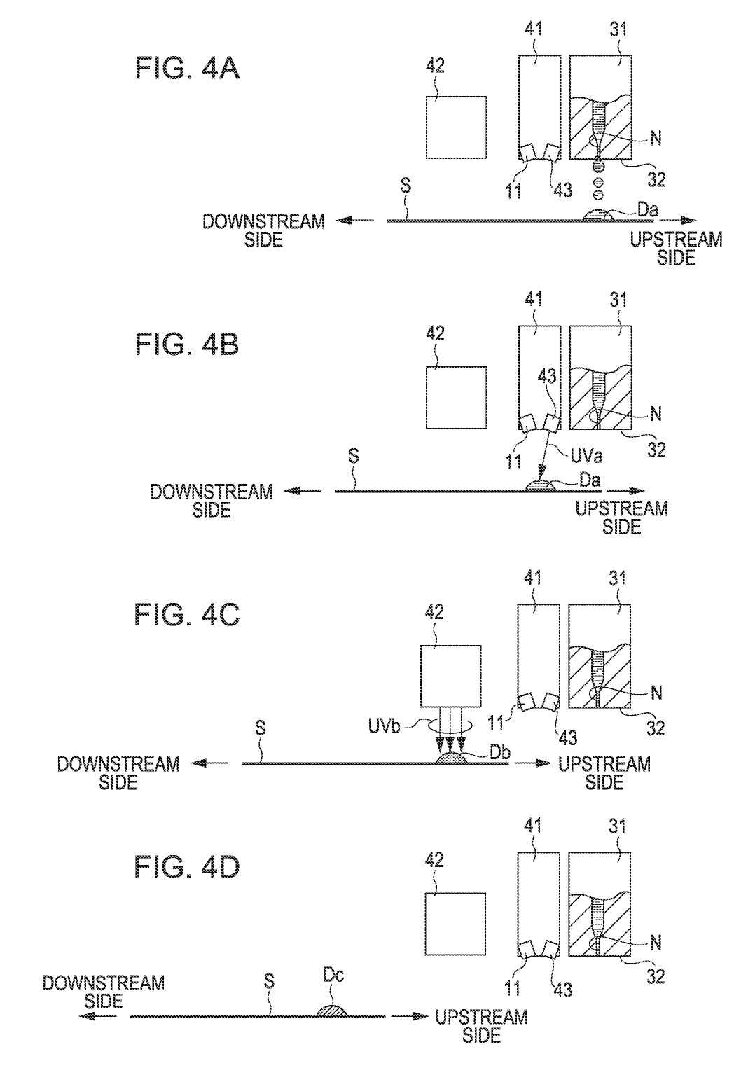

FIGS. 4A to 4D show a procedure of forming an image in the printer 1. In these drawings, for example, an example of an operation for printing a certain image, such as a text, a still image or the like, displayed on a display of the PC 110 is shown. In addition, the medium S is transported from the upstream side to the downstream side. The liquid droplet Da of an ink of a certain color is discharged to the medium S which is being transported by the head 31 such that the liquid droplet Da is impacted on the medium S (A). The temporary-curing irradiation unit 41 irradiates the temporary-curing light UVa including a predetermined wavelength range for curing the UV ink from light sources 43 to the liquid droplet Da of the ink so as to temporarily cure the liquid droplet Da (B). Then, the permanent-curing light UVb is irradiated to the temporarily cured liquid droplet Db of the color ink by the permanent-curing irradiation unit 42 (C). In this way, the liquid droplet Db is fixed on the medium S as a dot Dc forming the image (D).

### Dot Missing Inspection Unit

Next, the operation of the printer 1 including the above-described configuration when the dot missing inspection is optically performed will be described. The printer 1 includes the dot missing inspection unit 10 so as to perform the dot missing inspection in parallel with a printing operation procedure, without printing out an image provided in the dot missing inspection, such as a test pattern. The controller 60 controls the peripheral units 10, 20, 30 and 40 and enables the printer 1 to operate while selectively switching an operation mode for forming a certain image and an operation mode (inspection mode) for performing the dot missing inspection while an image in which dots of each color are aligned in a line shape or a matrix is printed as an inspection image for performing the dot missing inspection, as shown in FIGS. 4A to 4D.

In detail, the printer 1 includes the temporary-curing light sources 43 in correspondence with the pitch of the nozzles N of the line direction, and the light sources 43 also function as the light sources for optically performing the dot missing inspection. In this way, in the inspection mode, the operation for printing the inspection image is performed. However, the printer 1 of the present embodiment does not separately perform the dot missing inspection after printing the inspection image, but completes the dot missing inspection during the printing operation.

### Principle

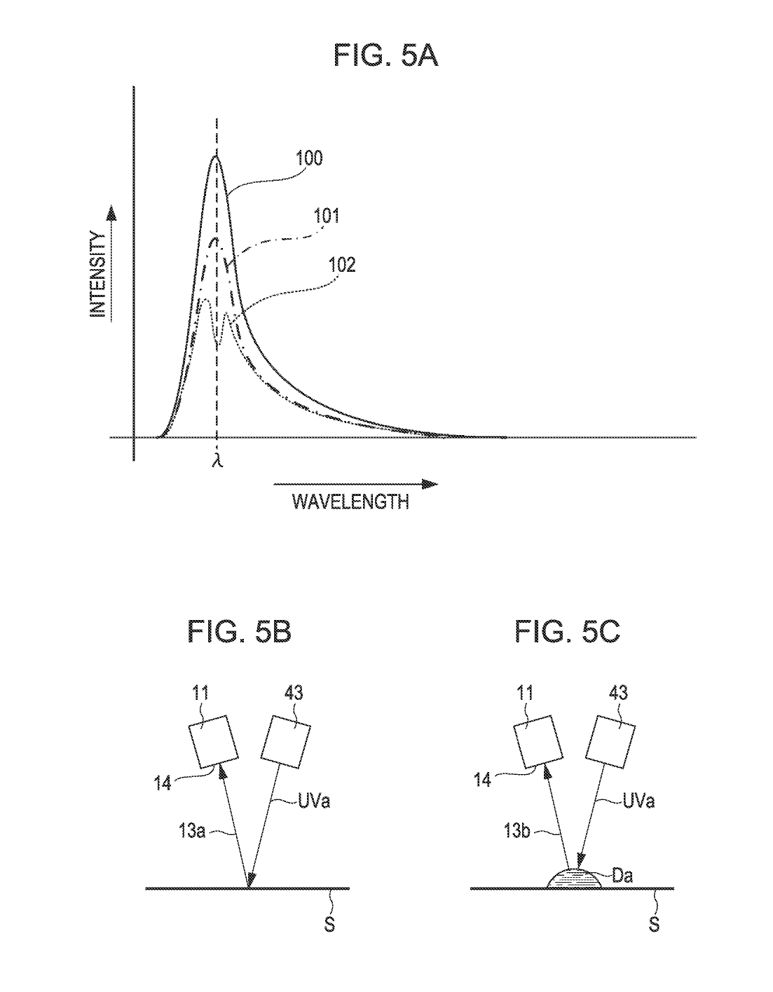

FIG. 5A which shows the principle of the dot missing inspection method of the printer 1 shows a relationship between the light intensities and the wavelengths of various lights associated with this inspection method. In FIG. 5A, a curved line 100 denoted by a solid line shows the characteristic of the temporary-curing light 100 from the light sources 43 of the temporary-curing irradiation unit 41. A curved line 101 denoted by a dashed-dotted line shows the characteristic of the light 13a received by the light receiving element 11 after the temporary-curing light is reflected from the surface of the medium S in which the ink droplet is not present, as shown in FIG. 5B. A curved line 102 denoted by a dotted line shows the characteristic of the light 13b received by the light receiving element 11 when the temporary-curing light UVa is irradiated to the ink droplet Da, as shown in FIG. 5C.

As described above, the light sources 43 of the temporary-curing irradiation unit 41 of the printer 1 are ultraviolet LEDs 43, and the characteristic of the temporary-curing light UVa denoted by the curved line 100 in FIG. 5A has a peak at a predetermined wavelength γ in an ultraviolet range. When the temporary-curing light UVa is directly irradiated to the surface of the medium S in which the ink droplet is not present as shown in FIG. 5B, the temporary-curing light UVa is diffused on the surface of the medium S and light 13a with intensity lower than that of the temporary-curing light UVa is reflected to the light receiving element 11 side. However, the wavelength characteristic curved line 101 of the reflected light 13a substantially maintains the shape of the curved line 100 of the temporary-curing light UVa.

In contrast, when the temporary-curing light UVa is irradiated to the ink droplet Da, a predetermined wavelength component of the temporary-curing light UVa is absorbed to the ink droplet Da and is consumed as energy for temporary curing. Here, the above peak wavelength γ is absorbed. Accordingly, the characteristic of the light 13b received by the light receiving element 11 is denoted by the curved line 102 in which the component of the wavelength γ is reduced, regardless of whether the ink is chromatic, white, or transparent.

This indicates that, if the ink droplet Da is present on the surface of the medium S, in other words, if the dot Dc is finally formed, received light intensity is lower as compared with the case where the dot Dc is not formed. Here, if a known wavelength selection filter for selectively transmitting light with the wavelength γ is disposed midway along an optical path from the surface of the medium S to a light receiving surface 14 of the light receiving element 11, it is possible to detect a difference in received light intensity. That is, it is possible to detect the presence/absence of the dot. In addition, with respect to the wavelength selection filter, a separate filter may be laminated and disposed so as to be brought into contact with the light receiving surface 14 of the light receiving element 11 or a thin film which becomes a filter may be directly formed on the light receiving surface 14 by coating or deposition.

### Inspection Mode

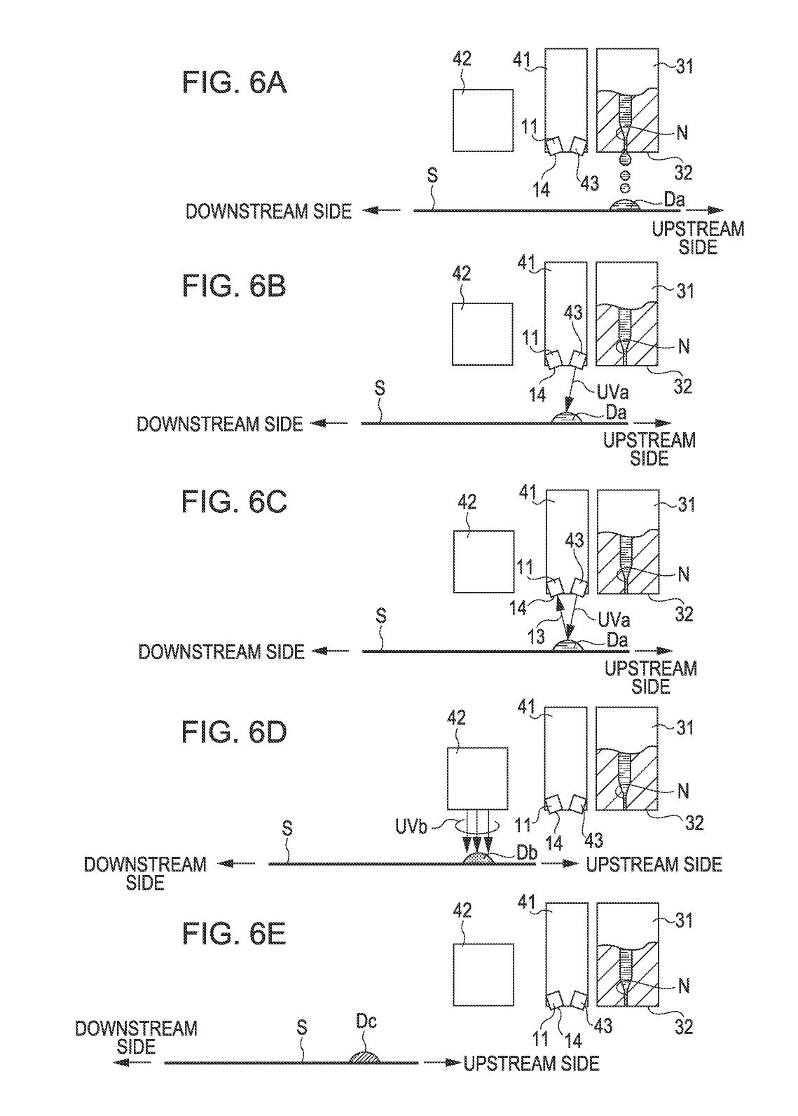

Hereinafter, the operation of the printer 1 in the inspection mode will be described as an example of the invention. FIGS. 6A to 6E show the schematic operation of the printer 1 in the inspection mode. In addition, the above-described wavelength selection filter is laminated and disposed on the light receiving surface 14 of the light receiving element 11. First, the liquid droplet Da of the ink is discharged and impacted on the medium S (A). Then, the temporary-curing light UVa is irradiated from the light sources 43 of the temporary-curing irradiation unit 41 to the liquid droplet Da of the ink (B). The component of the predetermined wavelength γ included in the temporary-curing light UVa is absorbed to the ink droplets Da so as to temporarily cure the ink droplets Da. The other wavelength component is reflected from the ink droplet Da or the medium S so as to enter into the light receiving element 11 as the inspection light 13 (C). Finally, the permanent-curing light UVb is irradiated to the ink droplet Db temporarily cured on the medium S by the permanent curing irradiation unit 42 (D) so as to fix the ink droplet Db as the dot Dc (E).

As shown in FIGS. 6A to 6E, in the inspection mode, the inspection light 13 enters into the light receiving element 11 in a series of printing operation procedures. The wavelength selection filter is provided on the optical path of the inspection light 13. In this way, the light receiving element 11 substantially outputs a signal according to received light intensity of the light with the predetermined wavelength γ. The signal processing circuit 12 of the dot missing inspection unit 10 samples and converts the output signal (received light intensity signal) from the light receiving element 11 into the light receiving data. The CPU 62 receives the light receiving data through the unit control circuit 64, executes the program stored in the memory 63, and processes the light receiving data, thereby determining the presence/absence of dot missing.

As an algorithm for determining the presence/absence of dot missing using the CPU 62, for example, the discharging timing of the ink droplet Da and the irradiation timing of the temporary-curing light UVa to the discharged ink droplet Da are controlled through the unit control circuit 64 and the light receiving data is acquired in synchronization with the irradiation timing.

In addition, as shown in FIG. 5B, the light receiving data corresponding to the received light intensity signal output from the light receiving element 11 in a state in which the ink droplet Da on the medium S is not present is stored in the memory 63 as an initial value, and the initial value and the light receiving data which is acquired as needed in the inspection mode are compared. Then, if it is less than the predetermined received light intensity, it is determined that the component of the predetermined wavelength γ in the temporary-curing light UVa is absorbed to the ink droplets Da, that is, the dot is correctly discharged, and thus dot missing is not present. In addition, diffusion or reflection characteristics of the temporary-curing light UVa may be different due to the type or individual differences of the medium S. In this case, a calibration operation for setting light receiving data obtained by irradiating the temporary-curing light UVa to the surface of the medium S at the time of the start of the dot missing inspection or the like as an initial value may be performed.

In addition, the CPU 62 stores a correspondence relationship between the ink droplet Da, to which the temporary-curing light UVa will be irradiated, and the nozzle N for discharging each ink droplet Da, and a determination result of the ink droplet Da as needed. In this way, when the presence of the dot missing is determined, it is possible to specify an abnormal nozzle N which does not correctly discharge the ink droplet Da. In addition, information (nozzle position, or the like) for specifying the presence/absence of dot missing or the abnormal nozzle N may be separately printed and output or displayed on the display screen of the PC 110 as the inspection result so as to be checked by a user.

### Regarding Other Embodiments

In the dot missing inspection method of the above embodiment, the presence/absence of dot missing is not determined by image processing or the like, but is determined depending on whether or not a specific wavelength component included in the light irradiated toward the medium S is absorbed by the ink droplet Da. To this end, even in a dot which is difficult to be optically detected, such as the case where a chromatic ink or a transparent ink is formed on the medium S, the case where a dot formed of a white ink is formed on a white medium, or the case where a dot formed of an ink of a certain color is formed on a medium of a color similar thereto, it is possible to accurately detect the presence/absence of dot missing.

In addition, since the presence/absence of dot missing is detected in the printing operation procedure, it is not necessary to perform the dot missing inspection with respect to an inspection image which is printed out once and it is possible to considerably shorten an inspection time. Since dot missing is detected in the printing operation, for example, in an industrial application in which a printed image itself is a product, the printing operation may be stopped when dot missing is detected. Accordingly, it is possible to prevent product manufacturing yield from deteriorating. In addition, although the general printing mode and the inspection mode are separate operation modes in the above embodiment, the dot missing inspection may be performed in parallel with the general printing operation.

### Other Embodiment of Printing Device

In the printer 1 of the above embodiment, two irradiation units including the temporary-curing irradiation unit 41 and the permanent-curing irradiation unit 42 are included as the configuration for irradiating the light to the UV ink. In this configuration, the temporary-curing irradiation unit 41 irradiates the light UVa with low energy sufficient for temporarily curing the UV ink and performs the dot missing inspection using the light UVa. To this end, it is not necessary to be concerned that light with high energy exceeding the light receiving sensitivity of the light receiving element 11 will be made incident such that the received light intensity signal is saturated. A high-performance light receiving element may be used such that the received light intensity signal is not saturated even with respect to light with high energy. The light sources 43 of the temporary-curing irradiation unit 41 shown in FIGS. 2A and 2B may be replaced with light sources capable of irradiating light with higher energy such that the permanent-curing irradiation unit 42 of FIGS. 2A and 2B is omitted or the temporary curing process shown in FIG. 4B or 6B may be replaced with a process of directly performing the permanent curing with respect to each ink droplet Da using the light sources with high energy. In such a configuration or process, since the dot missing inspection is performed in parallel with the process of directly performing the permanent curing with respect to each ink droplet Da, it is possible to shorten the time associated with the printing operation and, as a result, to shorten the time consumed for the dot missing inspection. In addition, it is possible to simplify the configuration of the UV irradiation unit 40. In either case, the configuration of the printer may be appropriately selected according to the use application (for example, general consumer application and industrial application) thereof or the like.

Although, in the printer 1 of the above embodiment, the piezoelectric type ink jet printer for applying a voltage to the driving element (piezoelectric element) so as to expand and contract the ink chamber such that a fluid is ejected is described, the method of discharging the liquid is not limited thereto. A thermal type method of generating air bubbles in nozzles using a heating element and ejecting a liquid by the air bubbles may be used.

In addition, the medium is not limited to paper and a material printed by an ink, such as cloth, a label surface of an optical disc (CD-R or the like) or a substrate, may be used. The medium may be continuously transported like a rolled sheet or may be individually transported as individual sheets.

The invention is applicable to, for example, a printing device for impacting discharged ink droplets onto a medium so as to form an image, such as an ink jet printer.

What is claimed is:

1. A method of inspecting presence/absence of dot missing in a printing device for discharging and impacting liquid droplets of a light curable ink from nozzles onto a medium, irradiating light to the impacted liquid droplets so as to cure the liquid droplets, and forming an image formed of minute dots on the medium, the method comprising:
at the printing device, discharging and impacting the liquid droplets of the light curable ink from the nozzles onto the medium;
irradiating light including a predetermined wavelength component for curing the light curable ink toward the liquid droplets impacted on the medium;
at a light receiving unit, selectively receiving the predetermined wavelength component from reflected light of the irradiated light and outputting a received light intensity signal; and
determining the presence/absence of the dot missing based on the received light intensity signal output from the light receiving unit and outputting inspection result data indicating the determination result.

2. The method according to claim 1, further including performing permanent curing,
wherein, in the step of irradiating the light, the light from a first light source for individually irradiating the light to the liquid droplets impacted on the medium is irradiated and the liquid droplets are temporarily cured so as to prevent flow of the liquid droplets,
in the step of receiving the light, each reflected light of the light individually irradiated by the first light source to each of the liquid droplets is received by the light receiving unit respectively and the individual received light intensity signal is output to each of the liquid droplets, and
in the step of performing the permanent curing, the light from a second light source is irradiated to the liquid droplets temporarily cured by the step of irradiating the light so as to further cure the liquid droplets to be fixed on the medium.

3. The method according to claim 1, wherein the step of discharging the ink is paused when the inspection result data indicating that missing dots are present is output in the step of outputting the inspection result data.

4. A printing device comprising a head unit including a plurality of nozzles, a light irradiation unit, a dot missing detection unit, and a control unit configured to control the head unit, the light irradiation unit and the dot missing detection unit, wherein:
the head unit discharges and lands liquid droplets of a light curable ink from the nozzles on a medium,
the light irradiation unit irradiates light including a predetermined wavelength component for curing the light curable inks toward the liquid droplets impacted on the medium,
the dot missing detection unit includes a light receiving unit and a wavelength selection unit,
the light receiving unit receives reflected light of the light irradiated by the light irradiation unit and outputs a received light intensity signal to the control unit,
the wavelength selection unit selectively transmits the light of the predetermined wavelength component through an optical path of the reflected light such that the transmitted light enters into the light receiving unit, and
the control unit determines presence/absence of dot missing based on the received light intensity signal from the light receiving unit and outputs inspection result data indicating the determination result.
